(19) United States
(12) Patent Application Publication
(10) Pub. No.: US 2018/0026743 A1
(43) Pub. Date: Jan. 25, 2018

(54) Method and Apparatus for Feeding Back and Receiving CQI and Communications System

(71) Applicant: FUJITSU LIMITED, Kawasaki-shi (JP)

(72) Inventors: Jian ZHANG, Beijing (CN); Xin WANG, Beijing (CN); Hua ZHOU, Beijing (CN)

(73) Assignee: FUJITSU LIMITED, Kawasaki-shi (JP)

(21) Appl. No.: 15/723,577

(22) Filed: Oct. 3, 2017

Related U.S. Application Data
(63) Continuation of application No. PCT/CN2015/076717, filed on Apr. 16, 2015.

(51) Int. Cl. H04L 1/00; H04W 72/04; H04B 7/06

(52) U.S. Cl. CPC H04L 1/0026; H04B 7/0632; H04W 72/0413; H04W 72/085

(57) ABSTRACT

A method and apparatus for feeding back and receiving a CQI and a communications system. The method for feeding back a CQI includes: receiving by a user equipment indication information for NOMA CQI feedback transmitted by a base station, the indication information including at least an NOMA power allocation factor; calculating an NOMA signal-to-interference plus noise ratio based on the NOMA power allocation factor; obtaining a corresponding NOMA CQI based on the NOMA signal-to-interference plus noise ratio; and feeding back the NOMA CQI to the base station. Therefore, by feeding back the NOMA CQI by the user equipment, quantization error accumulation may be reduced and accuracy of MCS selection may be enhanced.

### CROSS REFERENCE TO RELATED APPLICATIONS

This application is a continuation application of International Application PCT/CN2015/076717 filed on Apr. 16, 2015, the entire contents of which are incorporated herein by reference.

### TECHNICAL FIELD

This disclosure relates to the field of communications technologies, and in particular to a method and apparatus for feeding back and receiving a non-orthogonal multiple access (NOMA) channel quality indicator (CQI) and a communications system.

### BACKGROUND

The theoretical studies of the 5th-generation (5G) mobile communications technologies have been gradually developed. One of requirements on a 5G communications system is supporting a system capacity higher than that of 4G (such as 1000 times) and a larger number of connected terminals than that of 4G (such as 100 times). All previous generations of mobile communications adopt an orthogonal multiple access technology, and it is shown by studies that a non-orthogonal multiple access technology may achieve a capacity domain larger than that of the orthogonal multiple access technology, which theoretical teachings make the non-orthogonal multiple access technology become one of key technologies in the study of 5G.

One of methods for achieving non-orthogonality is non-orthogonality in a power domain, and a representative technology of which, NOMA, has been included in a discussion scope of LTE (Long Term Evolution) Release 13. The NOMA technology is based on a superposed code theory, in which a transmitting device transmits superposed symbols, and a receiving device needs to use a successive interference cancel (SIC) technology to separate and recover data information. For a case where the transmitting device uses a single antenna, all capacity domains of downlink broadcast channels and uplink multiple access channels may be theoretically achieved in the NOMA technology.

Transceiving models in orthogonal and non-orthogonal modes are given below taking downlink channels of two user equipments (UEs) as examples. Assuming that a base station and a user equipment use single antennas. UE 1 is located at a center of a cell, a channel experienced by it is denoted by h₁, and its noise is denoted by n₁; and UE 2 is located at an edge of the cell, a channel experienced by it is denoted by h₂, and its noise is denoted by n₂. The base station transmits a symbol s₁ to UE 1, transmits a symbol s₂ to UE 2, and its total power is P.

For the orthogonal mode, for example, the base station uses different time or frequency resources to transmit symbols of UE 1 and UE 2, and reception symbols of UE 1 and UE 2 may respectively be expressed as follows:

y₁^{OMA}=\sqrt{P}h₁s₁+n₁ (1)

y₂^{OMA}=\sqrt{P}h₂s₂+n₂ (2).

For the orthogonal mode, the user equipment independently demodulates data symbols of its own.

And for the non-orthogonal mode, the base station allocates different power for different symbols, and transmits a superposed symbol in the power domain by using identical time frequency resources.

Assuming power allocated for two user equipments is P₁ and P₂, respectively, where, P₁+P₂=P, the superposed symbol is \sqrt{P₁}s₁+\sqrt{P₂}s₂, and reception symbols of UE 1 and UE 2 may respectively be expressed as follows:

y₁^{NOMA}=h₁(\sqrt{P₁}s₁+\sqrt{P₂}s₂)+n₁ (3),

y₂^{NOMA}=h₂(\sqrt{P₁}s₁+\sqrt{P₂}s₂)+n₂ (4).

For the non-orthogonal mode, UE 2 at cell-edge independently demodulates the symbol s₂ of its own, and UE 1 at cell-center needs to use successive interference cancel to demodulate the symbol s₁ of its own. For UE 1, as it has a channel condition better than that of UE 2 at cell-edge, it is also able to demodulate the symbol s₂, perform interference cancel after demodulating s₂ to eliminate interference of s₂, obtain an intermediary result y₁^{SIC}=y₁^{NOMA}−h₁\sqrt{P₂}s₂ after the interference cancel, and hence demodulate the symbol s₁ of its own.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that in an existing scheme, a user equipment feeds back an orthogonal frequency division multiplexing (OFDM) CQI to a base station, and the base station selects an NOMA modulation coding scheme (MCS) according to the OFDM CQI. As a CQI itself is quantization of a signal to interference plus noise ratio (SINR), if the base station calculates an NOMA SINR based on a quantized SINR, quantization error accumulation will be resulted in, and a calculation result may further deviate from a real value of the NOMA SINR, thereby affecting accuracy of selection of an MCS.

Embodiments of this disclosure provide a method and apparatus for feeding back and receiving an NOMA CQI and a communications system, in which a user equipment is permitted to feed back an NOMA CQI, thereby enhancing accuracy of selection of an MCS.

According to a first aspect of the embodiments of this disclosure, there is provided a method for feeding back a CQI, applicable to a user equipment of an NOMA system, and the method includes:

receiving indication information for NOMA CQI feedback transmitted by a base station, the indication information at least including an NOMA power allocation factor;

calculating an NOMA SINR based on the NOMA power allocation factor;

obtaining a corresponding NOMA CQI based on the NOMA SINR; and

feeding back the NOMA CQI to the base station.

According to a second aspect of the embodiments of this disclosure, there is provided an apparatus for feeding back a CQI, configured in a user equipment of an NOMA system, and the apparatus includes:

an information receiving unit configured to receive indication information for NOMA CQI feedback transmitted by a base station, the indication information at least including an NOMA power allocation factor;

a calculating unit configured to calculate an NOMA signal to interference plus noise ratio (SINR) based on the NOMA power allocation factor;

an NOMA indicator obtaining unit configured to obtain a corresponding NOMA CQI based on the NOMA SINR; and

an NOMA indicator feedback unit configured to feed back the NOMA CQI to the base station.

According to a third aspect of the embodiments of this disclosure, there is provided a method for receiving a CQI, applicable to a base station of an NOMA system, and the method includes:

transmitting indication information for an NOMA CQI feedback to a user equipment, the indication information at least including an NOMA power allocation factor; and

receiving an NOMA CQI fed back by the user equipment.

According to a fourth aspect of the embodiments of this disclosure, there is provided an apparatus for receiving a CQI, configured in a base station of an NOMA system, and the apparatus includes:

an information transmitting unit configured to transmit indication information for an NOMA CQI feedback to a user equipment, the indication information at least including an NOMA power allocation factor; and

an NOMA indicator receiving unit configured to receive an NOMA CQI fed back by the user equipment.

According to a fifth aspect of the embodiments of this disclosure, there is provided a communications system using NOMA, the communications system including:

a base station configured to transmit indication information for NOMA CQI feedback to a user equipment, the indication information at least including an NOMA power allocation factor, and receive an NOMA CQI fed back by the user equipment; and

a user equipment configured to receive the indication information for NOMA CQI feedback transmitted by the base station, calculate an NOMA SINR based on the NOMA power allocation factor, obtain a corresponding NOMA CQI based on the NOMA SINR, and feed back the NOMA CQI to the base station.

According to another aspect of the embodiments of this disclosure, there is provided a computer readable program code, which, when executed in a base station, will cause a computer unit to carry out the method for receiving a CQI as described above in the base station.

According to a further aspect of the embodiments of this disclosure, there is provided a computer readable medium, including a computer readable program code, which will cause a computer unit to carry out the method for receiving a CQI as described above in a base station.

According to still another aspect of the embodiments of this disclosure, there is provided a computer readable program code, which, when executed in a UE, will cause a computer unit to carry out the method for feeding back a CQI as described above in the UE.

According to yet another aspect of the embodiments of this disclosure, there is provided a computer readable medium, including a computer readable program code, which will cause a computer unit to carry out the method for feeding back a CQI as described above in a UE.

An advantage of the embodiments of this disclosure exists in that the user equipment receives the NOMA power allocation factor transmitted by the base station, calculates an NOMA SINR based on the NOMA power allocation factor, obtains an NOMA CQI to which the NOMA SINR corresponds, and feeds back the NOMA CQI to the base station. Therefore, by feeding back the NOMA CQI by the user equipment, quantization error accumulation may be reduced and accuracy of MCS selection may be enhanced.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a flowchart of the method for feeding back a CQI of Embodiment 1 of this disclosure;

FIG. 2 is another flowchart of the method for feeding back a CQI of Embodiment 1 of this disclosure;

FIG. 3 is a flowchart of the method for receiving a CQI of Embodiment 2 of this disclosure;

FIG. 4 is another flowchart of the method for receiving a CQI of Embodiment 2 of this disclosure;

FIG. 5 is a schematic diagram of the apparatus for feeding back a CQI of Embodiment 3 of this disclosure;

FIG. 6 is another schematic diagram of the apparatus for feeding back a CQI of Embodiment 3 of this disclosure;

FIG. 7 is a schematic diagram of the user equipment of Embodiment 3 of this disclosure;

FIG. 8 is a schematic diagram of the apparatus for receiving a CQI of Embodiment 4 of this disclosure;

FIG. 9 is another schematic diagram of the apparatus for receiving a CQI of Embodiment 4 of this disclosure;

FIG. 10 is a schematic diagram of the base station of Embodiment 4 of this disclosure; and

FIG. 11 is a schematic diagram of the communications system of Embodiment 5 of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In an embodiment, SINRs of user equipments under a condition of non-NOMA (i.e. legacy OFDM) may be obtained from above formulae (1) and (2), which are expressed as:

$$\begin{matrix}{SINR}_{1} = \frac{P {\vert {h}_{1} \vert}^{2}}{{N}_{0}} , & ( 5 ) \\ {SINR}_{2} = \frac{P {\vert {h}_{2} \vert}^{2}}{{N}_{0}} . & ( 6 )\end{matrix}$$

And SINRs of user equipments under a condition of NOMA may be obtained from above formulae (3) and (4), which are expressed as:

$$\begin{matrix}{SINR}_{1}^{NOMA} = {α}_{1} {SINR}_{1} , & ( 7 ) \\ {SINR}_{2}^{NOMA} = \frac{{α}_{2} {SINR}_{2}}{{α}_{1} {SINR}_{1} + 1} . & ( 8 )\end{matrix}$$

where, α₁, α₂ are power allocation factors, which satisfy P₁=α₁P, P₂=α₂P, and N₀ is noise power.

Thus, a base station may calculate an NOMA SINR according to a non-NOMA SINR. In a practical system, the base station obtains an SINR based on feedback of a user equipment. For example, in an LTE system, a user equipment performs OFDM CQI feedback, and a base station selects an MCS based on the fed back CQI.

Such an integral process is actually to quantize a real SINR of the user equipment, and a result of the quantization is obtaining a modulation scheme and code rate suitable for current transmission. As a CQI itself is quantization of an SINR, if the base station calculates an NOMA SINR based on a quantized SINR, quantization error accumulation will be resulted in, and a calculation result may further deviate from a real value of the NOMA SINR, thereby affecting accuracy of selection of an MCS.

The embodiments of this disclosure provide a scheme for improving accuracy of feedback of NOMA; wherein, legacy OFDM CQI feedback is used to determine NOMA power allocation; furthermore, a user equipment is permitted to feed back NOMA CQI to further enhance accuracy of selection of an MCS. The embodiments of this disclosure shall be described below in detail.

### Embodiment 1

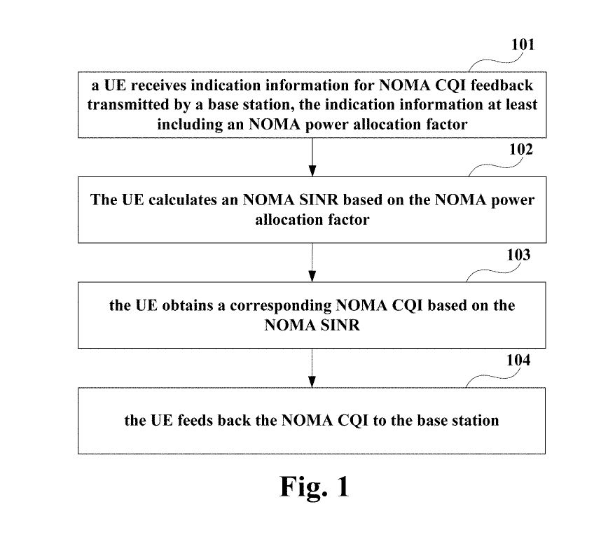

The embodiment of this disclosure provides a method for feeding back a CQI, applicable to a user equipment of an NOMA system. FIG. 1 is a flowchart of the method for feeding back a CQI of the embodiment of this disclosure. As shown in FIG. 1, the method includes:

block 101: a user equipment receives indication information for NOMA CQI feedback transmitted by a base station, the indication information at least including an NOMA power allocation factor;

block 102: the user equipment calculates an NOMA SINR based on the NOMA power allocation factor;

block 103: the user equipment obtains a corresponding NOMA CQI based on the NOMA SINR; and

block 104: the user equipment feeds back the NOMA CQI to the base station.

In this embodiment, the base station may use a physical downlink control channel (PDCCH) or radio resource control (RRC) signaling to notify the user equipment that it is currently in an NOMA transmission mode, and notify the user equipment of information necessary for performing NOMA demodulation and decoding, which includes at least the NOMA power allocation factor.

When the user equipment is configured to need to perform NOMA CQI feedback, the user equipment will calculate the NOMA SINR according to above formulae (7) and (8); where, α₁ and α₂ are the power allocation factors. Other parameters of formulae (7) and (8) may be obtained by the user equipment directly from the base station side, or may be derived from parameters transmitted by the base station, and the relevant art may be referred to.

In this embodiment, after calculating the NOMA SINR, the user equipment may obtain the corresponding NOMA CQI according to the NOMA SINR. In particular, the NOMA CQI to which the NOMA SINR corresponds may be found by looking up a CQI table that supports NOMA or a CQI table that supports OFDM, and then the NOMA CQI is fed back to the base station. As the calculation of the NOMA SINR is performed at the user equipment side, the used SINR is an estimated value of actual measurement, but not a quantized result. Hence, quantization error accumulation may be reduced and accuracy of MCS selection may be enhanced.

In this embodiment, the NOMA CQI is obtained according to the NOMA SINR, and the NOMA SINR is obtained by the user equipment according to the NOMA power allocation factor transmitted by the base station and whether SIC is performed. Thus, what is different from the OFDM CQI in the existing art is that the NOMA CQI in the embodiment of this disclosure embodies an effect of the NOMA power allocation; and furthermore, the NOMA CQI in the embodiment of this disclosure embodies an effect of interference between user equipments and an effect of SIC.

In this embodiment, the indication information may further include successive interference cancel (SIC) indication information and/or MCS information. For example, the SIC indication information may be used to indicate whether the user equipment needs to perform SIC, and for the user equipment needing to perform SIC, it is further used to notify the user equipment of an MCS used for an interference signal needing to be cancelled.

In this embodiment, the user equipment may store a CQI table that supports the NOMA in advance. The CQI table that supports the NOMA may be formed by modifying a legacy CQI table that supports the OFDM. And the CQI table that supports NOMA may support code rates lower than that of OFDM relative to the CQI table that supports OFDM.

TABLE 1
CQI table that supports OFDM

| CQI index | Modulation | Code rate × 1024 | Efficiency |
|---|---|---|---|
| 0 | Out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

As shown in Table 2, the NOMA CQI table may be obtained by replacing items of high modulation orders and high code rates with items of lower code rates of QPSK (Quadrature Phase Shift Keying), and overhead of bits of CQI feedback will not be increased.

In this embodiment, the CQI table that supports NOMA may reuse a table in an existing standard, i.e. the CQI table that supports OFDM, or may be a newly-defined NOMA CQI table. And the CQI table that supports NOMA may be used in an NOMA transmission mode only, increase support for lower code rates of QPSK, and is used to adapt to a case of lowering of an SINR brought about by NOMA transmission.

In this embodiment, the user equipment may store the CQI table that supports OFDM (Table 1) and the CQI table that supports NOMA (Table 2) in advance. And the user equipment may feed back the OFDM CQI or the NOMA CQI according to indication of the base station. Furthermore, in performing the CQI feedback, the user equipment may feed back an NOMA CQI only, or may feed back both an NOMA CQI and a legacy OFDM CQI. And a particular implementation may be determined according to a practical scenario.

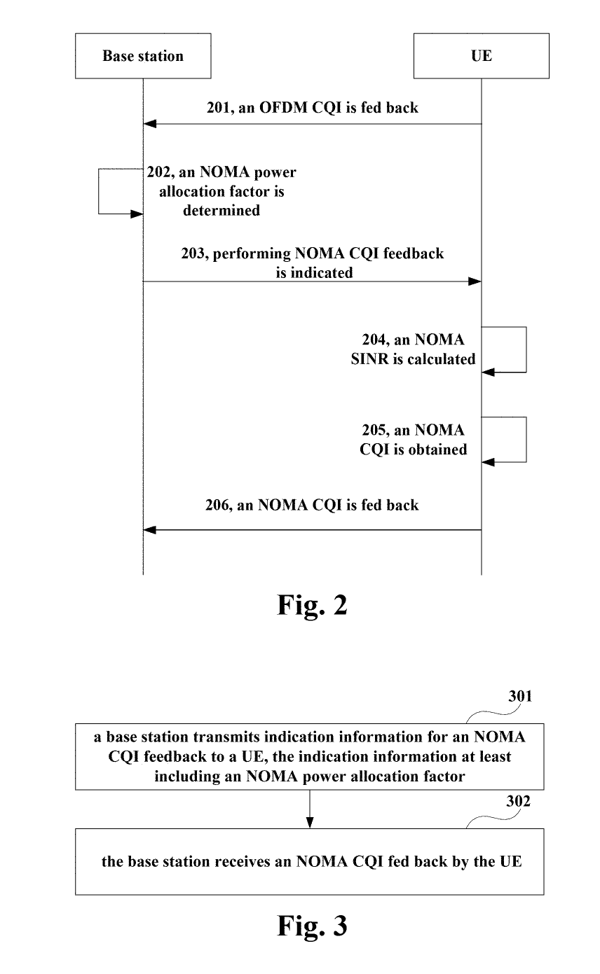

FIG. 2 is another flowchart of the method for feeding back a CQI of the embodiment of this disclosure. As shown in FIG. 2, the method includes:

201: the user equipment feeds back an OFDM CQI to the base station;

202: the base station obtains the OFDM SINR according to the OFDM CQI after receiving the OFDM CQI, and determines the NOMA power allocation factor according to the OFDM SINR;

at an initial stage, the user equipment may feed back a legacy OFDM CQI, and the base station may determine user scheduling and power allocation of NOMA by using the OFDM CQI information, that is, to determine the power allocation factor; and the relevant art may be referred to for how to perform NOMA scheduling and how to determine the NOMA power allocation factor;

203: the user equipment receives indication information for NOMA CQI feedback transmitted by the base station, the indication information at least including an NOMA power allocation factor;

204: the user equipment calculates an NOMA SINR based on the NOMA power allocation factor;

following formulae may be used for the calculation:

$${SINR}_{1}^{NOMA} = {α}_{1} {SINR}_{1} , and {SINR}_{2}^{NOMA} = \frac{{α}_{2} {SINR}_{2}}{{α}_{1} {SINR}_{1} + 1} ;$$

where, SINR₁^{NOMA} and SINR₂^{NOMA} are the NOMA SINRs; and SINR₁ and SINR₂ are OFDM SINRs; and other parameters in the above formulae than the power allocation factors may be obtained by the user equipment directly from the base station side, or may be derived from parameters transmitted by the base station;

205: the user equipment obtains a corresponding NOMA CQI based on the NOMA SINR;

in particular, a CQI table that supports NOMA may be looked up, or a CQI table that supports OFDM may be looked up; and by looking up these tables, the corresponding NOMA CQI may be obtained based on the NOMA SINR;

206: the user equipment feeds back the NOMA CQI to the base station.

It should be noted that the formulae in 204 are examples of the embodiment of this disclosure; however, this disclosure is not limited thereto. In this embodiment, the NOMA SINR is obtained by the user equipment according to the NOMA power allocation factor transmitted by the base station and whether SIC is performed. Thus, the NOMA CQI in the embodiment of this disclosure embodies an effect of the NOMA power allocation; and furthermore, the NOMA CQI in the embodiment of this disclosure embodies an effect of interference between user equipments and an effect of SIC.

It can be seen from the above embodiment that the user equipment receives the NOMA power allocation factor transmitted by the base station, calculates an NOMA SINR based on the NOMA power allocation factor, obtains an NOMA CQI to which the NOMA SINR corresponds, and feeds back the NOMA CQI to the base station. Therefore, by feeding back the NOMA CQI by the user equipment, quantization error accumulation may be reduced and accuracy of MCS selection may be enhanced.

### Embodiment 2

The embodiment of this disclosure provides a method for receiving a CQI, applicable to a base station of an NOMA system, with contents identical to those in Embodiment 1 being not going to be described herein any further.

FIG. 3 is a flowchart of the method for receiving a CQI of the embodiment of this disclosure. As shown in FIG. 3, the method includes:

block 301: a base station transmits indication information for an NOMA CQI feedback to a user equipment, the indication information at least including an NOMA power allocation factor; and

block 302: the base station receives an NOMA CQI fed back by the user equipment.

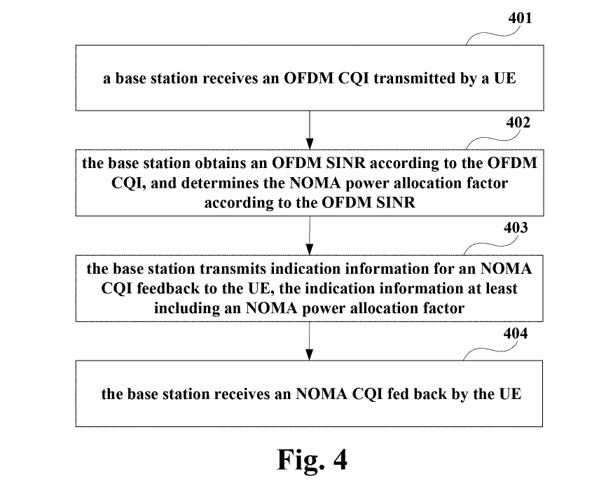

FIG. 4 is another flowchart of the method for receiving a CQI of the embodiment of this disclosure. As shown in FIG. 4, the method includes:

block 401: the base station receives an OFDM CQI transmitted by the user equipment;

block 402: the base station obtains an OFDM SINR according to the OFDM CQI, and determines an NOMA power allocation factor according to the OFDM SINR;

block 403: the base station transmits indication information for an NOMA CQI feedback to the user equipment, the indication information at least including the NOMA power allocation factor; and

block 404: the base station receives an NOMA CQI fed back by the user equipment.

In this embodiment, the indication information may further include SIC indication information and/or MCS information.

It can be seen from the above embodiment that the base station transmits the NOMA power allocation factor to the user equipment, the user equipment obtains the NOMA CQI based on the NOMA power allocation factor, and feeds back the NOMA CQI to the base station. Therefore, by feeding back the NOMA CQI by the user equipment, quantization error accumulation may be reduced and accuracy of MCS selection may be enhanced.

### Embodiment 3

The embodiment of this disclosure provides an apparatus for feeding back a CQI, configured in a user equipment of an NOMA system. The embodiment of this disclosure corresponds to the method for feeding back a CQI in Embodiment 1, with identical contents being not going to be described herein any further.

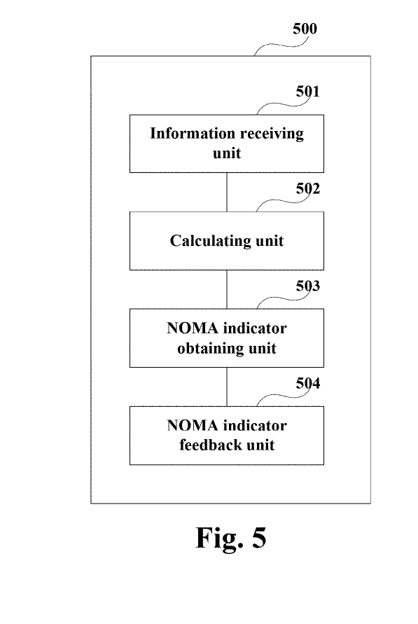

FIG. 5 is a schematic diagram of the apparatus for feeding back a CQI of the embodiment of this disclosure. As shown in FIG. 5, the apparatus 500 for feeding back a CQI includes:

an information receiving unit 501 configured to receive indication information for NOMA CQI feedback transmitted by a base station, the indication information at least including an NOMA power allocation factor;

a calculating unit 502 configured to calculate an NOMA signal to interference plus noise ratio (SINR) based on the NOMA power allocation factor;

an NOMA indicator obtaining unit 503 configured to obtain a corresponding NOMA CQI based on the NOMA SINR; and

an NOMA indicator feedback unit 504 configured to feed back the NOMA CQI to the base station.

In this embodiment, the NOMA indicator obtaining unit 503 may be configured to obtain the NOMA CQI by looking up a CQI table that supports NOMA or a CQI table that supports OFDM.

In this embodiment, the indication information may further include SIC indication information and/or MCS information.

In this embodiment, the calculating unit 502 may be configured to use the following formulae:

$${SINR}_{1}^{NOMA} = {α}_{1} {SINR}_{1} , and {SINR}_{2}^{NOMA} = \frac{{α}_{2} {SINR}_{2}}{{α}_{1} {SINR}_{1} + 1} ;$$

where, SINR₁^{NOMA} and SINR₂^{NOMA} are the NOMA SINRs, SINR₁ and SINR₂ are OFDM SINRs, and α₁ and α₂ are the NOMA power allocation factors.

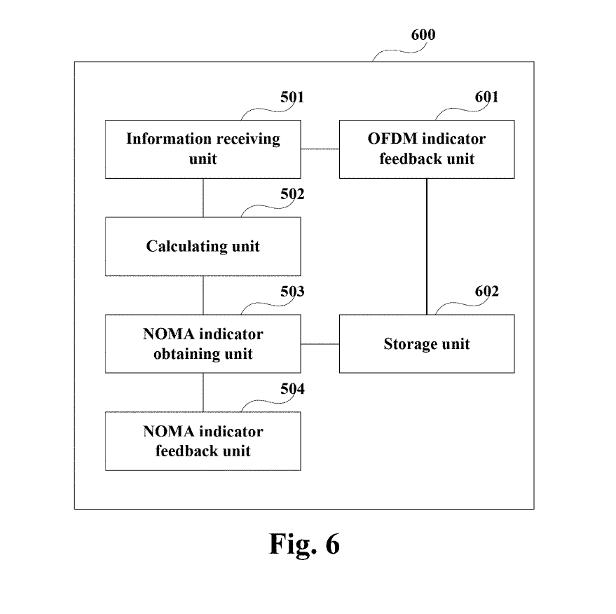

FIG. 6 is another schematic diagram of the apparatus for feeding back a CQI of the embodiment of this disclosure. As shown in FIG. 6, the apparatus 600 for feeding back a CQI includes an information receiving unit 501, a calculating unit 502, an NOMA indicator obtaining unit 503 and an NOMA indicator feedback unit 504, as described above.

As shown in FIG. 6, the apparatus 600 for feeding back a CQI may further include:

an OFDM indicator feedback unit 601 configured to feed back an OFDM CQI to the base station, such that the base station determines the NOMA power allocation factor according to the OFDM CQI.

As shown in FIG. 6, the apparatus 600 for feeding back a CQI may further include:

a storage unit 602 configured to store the CQI table that supports NOMA. Furthermore, the storage unit 602 may store the CQI table that supports OFDM.

In this embodiment, the CQI table that supports NOMA may support code rates lower than that of OFDM relative to the CQI table that supports OFDM.

The embodiment of this disclosure further provides a user equipment, configured with the above apparatus 500 or 600 for feeding back a CQI.

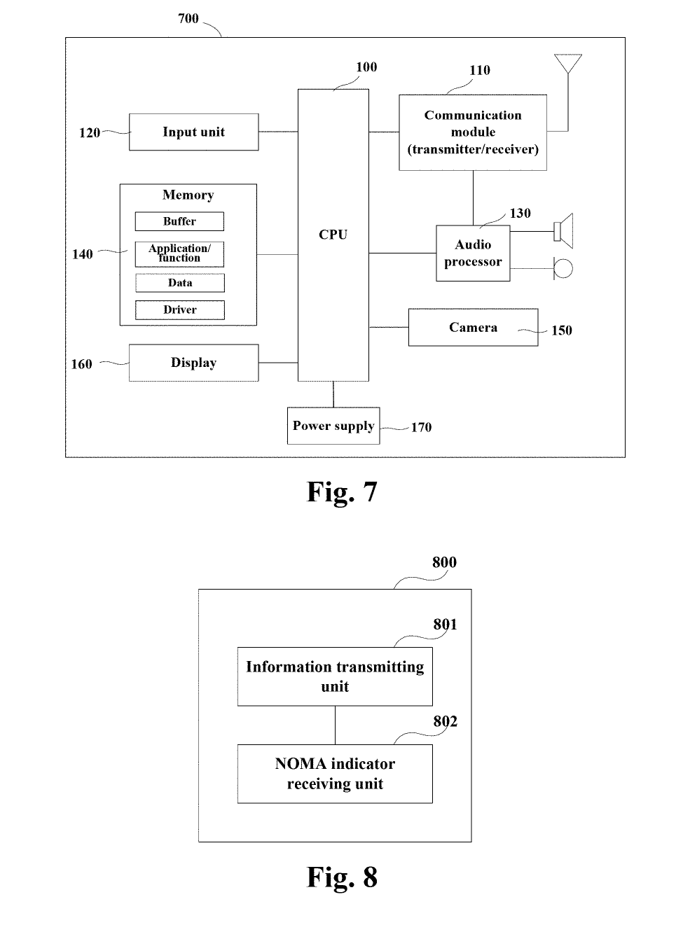

FIG. 7 is a schematic diagram of the user equipment of the embodiment of this disclosure. As shown in FIG. 7, the user equipment 700 may include a central processing unit (CPU) 100 and a memory 140, the memory 140 being coupled to the central processing unit 100. It should be noted that this figure is illustrative only, and other types of structures may also be used, so as to supplement or replace this structure and achieve a telecommunications function or other functions.

In an implementation, the functions of the apparatus 500 or 600 for feeding back a CQI may be integrated into the central processing unit 100. For example, the central processing unit 100 may be configured to perform following control: receiving indication information for NOMA CQI feedback transmitted by a base station, the indication information at least including an NOMA power allocation factor; calculating an NOMA SINR based on the NOMA power allocation factor; obtaining a corresponding NOMA CQI based on the NOMA SINR; and feeding back the NOMA CQI to the base station.

In another implementation, the apparatus 500 or 600 for feeding back a CQI and the central processing unit 100 may be configured separately. For example, the apparatus 500 or 600 for feeding back a CQI may be configured as a chip connected to the central processing unit 100, with its functions being realized under control of the central processing unit 100.

As shown in FIG. 7, the user equipment 700 may further include a communications module 110, an input unit 120, an audio processor 130, a memory 140, a camera 150, a display 160 and a power supply 170. Functions of the above components are similar to those in the relevant art, and shall not be described herein any further. It should be noted that the user equipment 700 does not necessarily include all the parts shown in FIG. 7, and furthermore, the user equipment 700 may include parts not shown in FIG. 7, and the relevant art may be referred to.

It can be seen from the above embodiment that the user equipment receives the NOMA power allocation factor transmitted by the base station, calculates an NOMA SINR based on the NOMA power allocation factor, obtains an NOMA CQI to which the NOMA SINR corresponds, and feeds back the NOMA CQI to the base station. Therefore, by feeding back the NOMA CQI by the user equipment, quantization error accumulation may be reduced and accuracy of MCS selection may be enhanced.

### Embodiment 4

The embodiment of this disclosure provides an apparatus for receiving a CQI, configured in a base station of an NOMA system. The embodiment of this disclosure corresponds to the method for receiving a CQI in Embodiment 2, with identical contents being not going to be described herein any further.

FIG. 8 is a schematic diagram of the apparatus for receiving of the embodiment of this disclosure. As shown in FIG. 8, the apparatus 800 for receiving a CQI includes:

an information transmitting unit 801 configured to transmit indication information for an NOMA CQI feedback to a user equipment, the indication information at least including an NOMA power allocation factor; and

an NOMA indicator receiving unit 802 configured to receive an NOMA CQI fed back by the user equipment.

FIG. 9 is another schematic diagram of the apparatus for receiving of the embodiment of this disclosure. As shown in FIG. 9, the apparatus 900 for receiving a CQI includes an information transmitting unit 801 and an NOMA indicator receiving unit 802, as described above.

As shown in FIG. 9, the apparatus 900 for receiving a CQI may further include:

an OFDM indicator receiving unit 901 configured to receive an OFDM CQI transmitted by the user equipment; and

an information determining unit 902 configured to obtain an OFDM SINR according to the OFDM CQI, and determine the NOMA power allocation factor according to the OFDM SINR.

In this embodiment, the indication information may further include SIC indication information and/or MCS information.

The embodiment of this disclosure further provides a base station, configured with the above apparatus 800 or 900 for receiving a CQI.

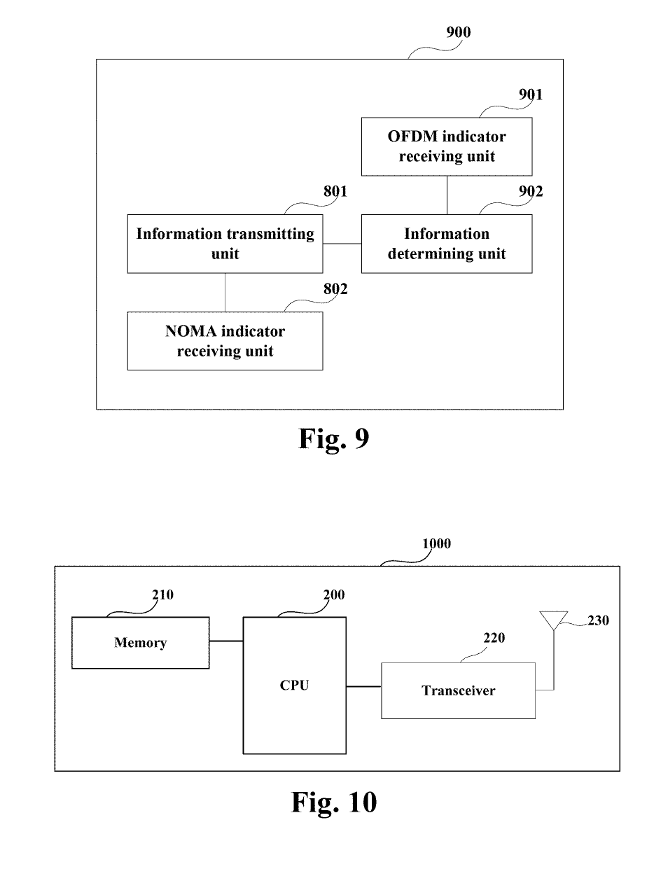

FIG. 10 is a schematic diagram of the base station of the embodiment of this disclosure. As shown in FIG. 10, the base station 1000 may include a central processing unit 200 and a memory 210, the memory 210 being coupled to the central processing unit 200. The memory 210 may store various data, and furthermore, it may store a program for information processing, and execute the program under control of the central processing unit 200.

For example, the base station 1000 may carry out the method for receiving a CQI described in Embodiment 2. And the central processing unit 200 may be configured to carry out the functions of the apparatus 800 or 900 for receiving a CQI, that is, the central processing unit 200 may be configured to perform the following control: transmitting indication information for an NOMA CQI feedback to a user equipment, the indication information at least including an NOMA power allocation factor; and receiving an NOMA CQI fed back by the user equipment.

Furthermore, as shown in FIG. 10, the base station 1000 may include a transceiver 220, and an antenna 230, etc. Functions of the above components are similar to those in the relevant art, and shall not be described herein any further. It should be noted that the base station 1000 does not necessarily include all the parts shown in FIG. 10, and furthermore, the base station 1000 may include parts not shown in FIG. 10, and the relevant art may be referred to.

It can be seen from the above embodiment that the base station transmits the NOMA power allocation factor to the user equipment, the user equipment obtains the NOMA CQI based on the NOMA power allocation factor, and feeds back the NOMA CQI to the base station. Therefore, by feeding back the NOMA CQI by the user equipment, quantization error accumulation may be reduced and accuracy of MCS selection may be enhanced.

### Embodiment 5

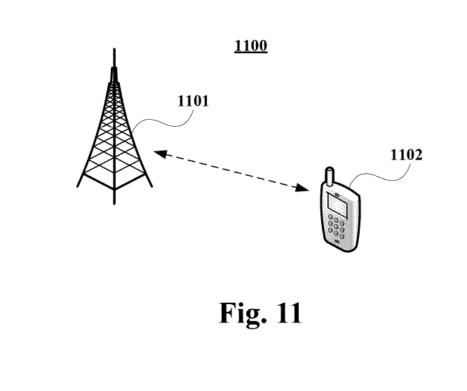

The embodiment of this disclosure provides a communications system using NOMA, with contents identical to those in embodiments 1-4 being not going to be described herein any further. FIG. 11 is a schematic diagram of the communications system of the embodiment of this disclosure. As shown in FIG. 11, the communications system 1100 includes a base station 1101 and a user equipment 1102.

The base station 1101 is configured to transmit indication information for NOMA CQI feedback to the user equipment, the indication information at least including an NOMA power allocation factor, and receive an NOMA CQI fed back by the user equipment.

The user equipment 1102 is configured to receive the indication information for NOMA CQI feedback transmitted by the base station 1101, calculate an NOMA SINR based on the NOMA power allocation factor, obtain a corresponding NOMA CQI based on the NOMA SINR, and feed back the NOMA CQI to the base station 1101.

In this embodiment, the user equipment 1102 may obtain the NOMA CQI by looking up a CQI table that supports NOMA or a CQI table that supports OFDM.

In this embodiment, the user equipment 1102 is further configured to feed back an OFDM CQI to the base station, and the base station 1101 is further configured to obtain an OFDM SINR according to the OFDM CQI, and determine the NOMA power allocation factor according to the OFDM SINR.

An embodiment of the present disclosure provides a computer readable program code, which, when executed in a UE, will cause a computer unit to carry out the method for feeding back a CQI described in Embodiment 1 in the UE.

An embodiment of the present disclosure provides a computer readable medium, including a computer readable program code, which will cause a computer unit to carry out the method for feeding back a CQI described in Embodiment 1 in a UE.

An embodiment of the present disclosure provides a computer readable program code, which, when executed in a base station, will cause a computer unit to carry out the method for receiving a CQI described in Embodiment 2 in the base station.

An embodiment of the present disclosure provides a computer readable medium, including a computer readable program code, which will cause a computer unit to carry out the method for receiving a CQI described in Embodiment 2 in a base station.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communications combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. An apparatus for feeding back a channel quality indicator (CQI), configured in a user equipment of a non-orthogonal multiple access (NOMA) system, the apparatus comprising:
an information receiving unit configured to receive indication information for NOMA CQI feedback transmitted by a base station, the indication information at least comprising an NOMA power allocation factor;
a calculating unit configured to calculate an NOMA signal to interference plus noise ratio (SINR) based on the NOMA power allocation factor;
an NOMA indicator obtaining unit configured to obtain a corresponding NOMA CQI based on the NOMA SINR; and
an NOMA indicator feedback unit configured to feed back the NOMA CQI to the base station.

2. The apparatus according to claim 1, wherein the apparatus further comprises:
an OFDM indicator feedback unit configured to feed back an orthogonal frequency division multiplexing (OFDM) CQI to the base station, such that the base station determines the NOMA power allocation factor according to the OFDM CQI.

3. The apparatus according to claim 1, wherein the indication information further comprises successive interference cancel (SIC) indication information and/or modulation coding scheme (MCS) information.

4. The apparatus according to claim 1, wherein the NOMA indicator obtaining unit is further configured to obtain the NOMA CQI by looking up a CQI table that supports NOMA or a CQI table that supports OFDM.

5. The apparatus according to claim 4, wherein the apparatus further comprises:
a storage unit configured to store the CQI table that supports NOMA.

6. The apparatus according to claim 5, wherein the CQI table that supports NOMA supports code rates lower than that of OFDM relative to the CQI table that supports OFDM.

7. The apparatus according to claim 5, wherein the storage unit is further configured to store the CQI table that supports OFDM.

8. The apparatus according to claim 1, wherein the calculating unit is configured to use the following formulae:
$${SINR}_{1}^{NOMA} = {α}_{1} {SINR}_{1} , and$$
$${SINR}_{2}^{NOMA} = \frac{{α}_{2} {SINR}_{2}}{{α}_{1} {SINR}_{1} + 1} ;$$
where, SINR₁^{NOMA} and SINR₂^{NOMA} are the NOMA SINRs, SINR₁ and SINR₂ are OFDM SINRs, and α₁ and α₂ are the NOMA power allocation factors.

9. An apparatus for receiving a channel quality indicator (CQI), configured in a base station of a non-orthogonal multiple access (NOMA) system, the apparatus comprising:
an information transmitting unit configured to transmit indication information for an NOMA CQI feedback to a user equipment, the indication information at least comprising an NOMA power allocation factor; and
an NOMA indicator receiving unit configured to receive an NOMA CQI fed back by the user equipment.

10. The apparatus according to claim 9, wherein the apparatus further comprises:
an OFDM indicator receiving unit configured to receive an OFDM CQI transmitted by the user equipment; and
an information determining unit configured to obtain an OFDM SINR according to the OFDM CQI, and determine the NOMA power allocation factor according to the OFDM SINR.

11. The apparatus according to claim 9, wherein the indication information further comprises successive interference cancel indication information and/or modulation coding scheme information.

12. A communications system using non-orthogonal multiple access (NOMA), the communications system comprising:
a base station configured to transmit indication information for NOMA CQI feedback to a user equipment, the indication information at least comprising an NOMA power allocation factor, and receive an NOMA CQI fed back by the user equipment; and
a user equipment configured to receive the indication information for NOMA CQI feedback transmitted by the base station, calculate an NOMA SINR based on the NOMA power allocation factor, obtain a corresponding NOMA CQI based on the NOMA SINR, and feed back the NOMA CQI to the base station.

13. The communications system according to claim 12, wherein the user equipment is further configured to feed back an OFDM CQI to the base station;
and the base station is further configured to obtain an OFDM SINR according to the OFDM CQI, and determine the NOMA power allocation factor according to the OFDM SINR.

14. The communications system according to claim 12, wherein the user equipment is configured to obtain the NOMA CQI by looking up a CQI table that supports NOMA or a CQI table that supports OFDM.
